(19) United States
(12) Patent Application Publication
(10) Pub. No.: US 2011/0077060 A1
(43) Pub. Date: Mar. 31, 2011

(54) PORTABLE ELECTRONIC DEVICE

(75) Inventors: ZHENG SHI, Shenzhen City (CN); DIAN-HONG YE, Shenzhen City (CN)

(73) Assignees: SHENZHEN FUTAIHONG PRECISION INDUSTRY CO., LTD., ShenZhen City (CN); FIH (HONG KONG) LIMITED, Kowloon (HK)

(21) Appl. No.: 12/635,535

(22) Filed: Dec. 10, 2009

(30) Foreign Application Priority Data
Sep. 30, 2009 (CN) 200910308035.0

(51) Int. Cl. H04M 1/00

(52) U.S. Cl. 455/575.1

(57) ABSTRACT

A portable electronic device includes a main body, a cover assembled on the main body, and a knife tool. The knife tool includes an operating assembly, a blade, and an elastic element. The elastic element, the operating assembly, and the blade are received in the main body. The elastic element biases the blade away from the main body towards an opening.

### BACKGROUND

1. Technical Field

The present disclosure relates to portable electronic devices, and particularly to a portable electronic device equipped with a knife.

2. Description of Related Art

With the development of technology, many portable electronic devices (e.g., mobile phones and personal digital assistants) are designed to be multifunctional. For example, a mobile phone can also have the functions of capturing photos, receiving broadcasts, etc.

Mobile phones equipped with knife blades have been introduced. The mobile phone includes a main body and a knife tool assembled within the main body. The main body defines a chamber in a sidewall thereof. A shaft is secured in the chamber. The knife pivots on the shaft and is received in the chamber.

However, the knife may easily pivot out from the chamber, causing a dangerous situation.

Therefore, there is a room for improvement within the art.

### BRIEF DESCRIPTION OF THE DRAWINGS

Many aspects of the disclosure can be better understood with reference to the following drawings. The components in the drawings are not necessarily to scale, the emphasis instead being placed upon clearly illustrating the principles of the portable electronic device. Moreover, in the drawings, like reference numerals designate corresponding parts throughout the several views.

FIG. 1 is an isometric view of a portable electronic device according to an exemplary embodiment.

FIG. 2 is an exploded view of the portable electronic device shown in FIG. 1.

FIG. 3 is an exploded view of a knife tool shown in FIG. 2.

FIG. 4 is similar to FIG. 3, but from another angle.

FIG. 5 is an isometric view of a casing shown in FIG. 2.

FIG. 6 is a cut-away view of the portable electronic device shown in FIG. 1.

FIG. 7 is a cut-away view of the knife tool sliding out of the portable electronic device.

### DETAILED DESCRIPTION OF THE EMBODIMENT

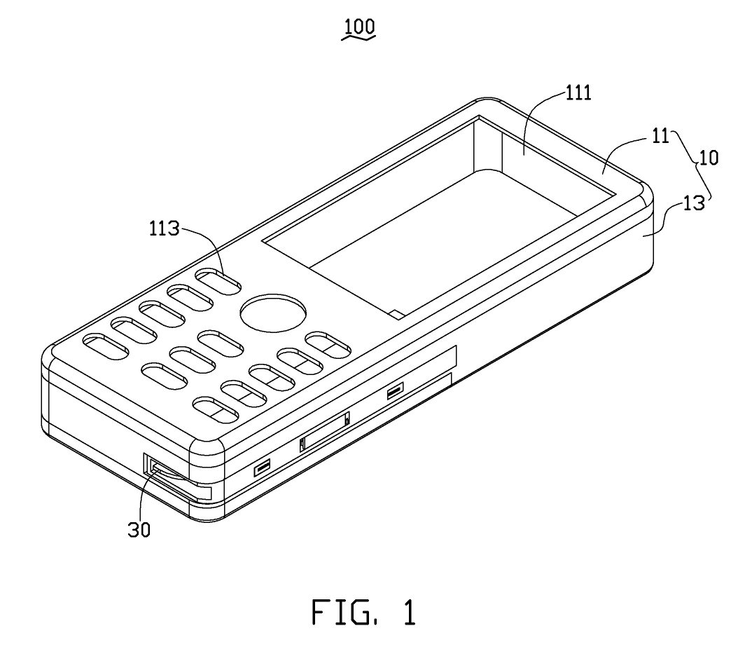

FIG. 1 shows an exemplary portable electronic device 100 including a housing 10 and a knife tool 30 received in the housing 10. The housing 10 includes a main body 13 and a cover 11 assembled to the main body 13.

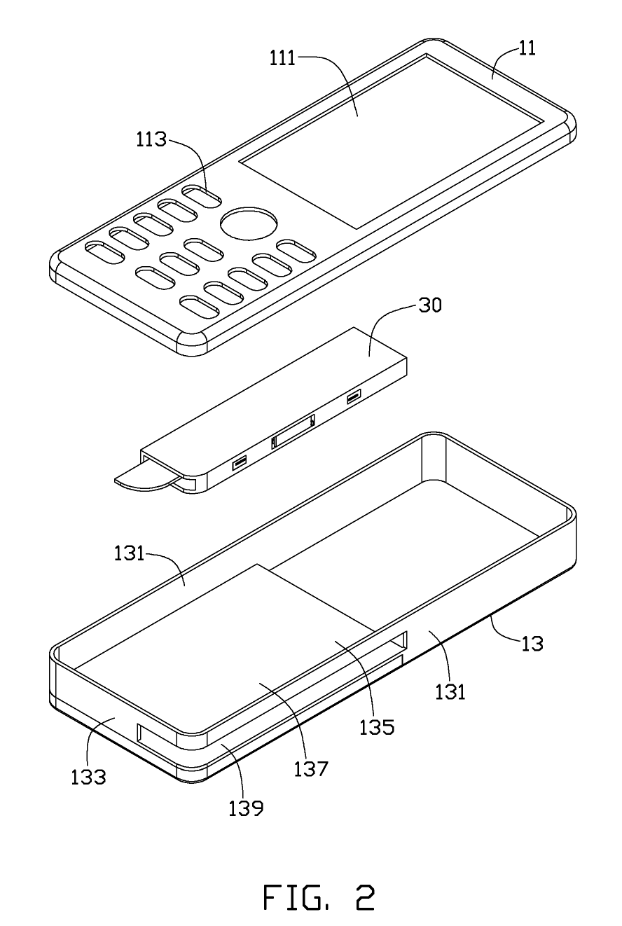

FIG. 2 shows the cover 11 including a first assembled area 111 and a second assembled area 113. The first assembled area 111 is configured to house a display screen providing operating information of the portable electronic device. The second assembled area 113 houses a keyboard enabling input of information. The main body 13 includes two sidewalls 131, two end walls 133 connecting to the sidewalls 131, and a divisional plate 135. The sidewalls 131 and the end walls 133 cooperatively define a receiving chamber 137. The divisional plate 135 is received in the receiving chamber 137, and resists the two sidewalls 131 and one of the end walls 133. The main body 13 further defines a through slot 139 in one of the sidewalls 131 and one of the end walls 133 connected to each other.

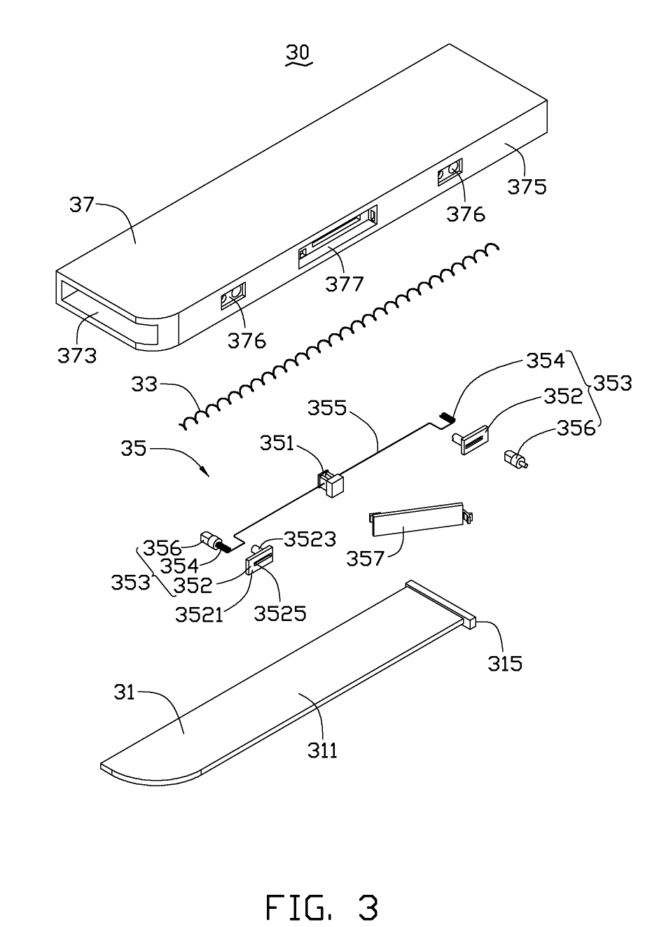

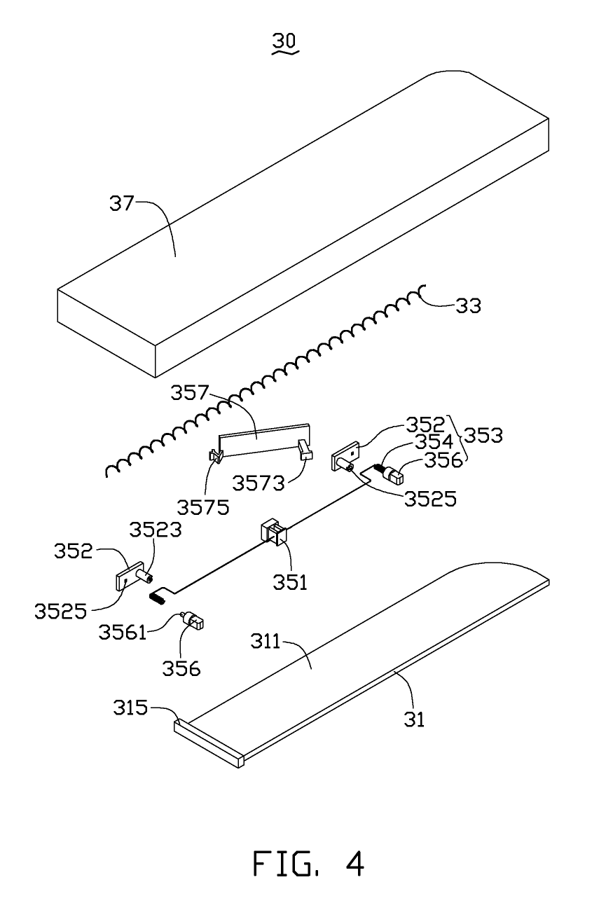

Referring to FIGS. 3 and 4, the knife tool 30 includes a blade 31, an elastic element 33, an operating assembly 35, and a casing 37 for receiving the blade 31, the elastic element 33, and the operating assembly 35. The blade 31 can be withdrawn from the casing 37 by the elastic element 33 and the operating assembly 35. The blade 31 includes a projection 315 secured on an end thereof and a blade body 311.

The operating assembly 35 includes a sliding element 351, two locating components 353, a cable 355, and a protective cover 357. The sliding element 351 is attached to the cable 355. Each of the locating components 353 includes a locating element 352, a spring 354, and a resisting element 356. The locating element 352 includes a plate 3521 and a hollow post 3523 perpendicularly positioned on the plate 3521. The post 3523 defines a through hole 3525 through which the cable 355 passes.

The resisting element 356 includes a protrusion 3561 extending from an end thereof. The spring 354 is configured to provide a restoring force to the projection 315. The cable 355 is steel, and each resisting element 356 can be secured on an end of the cable 355. The protective cover 357 includes a connecting arm 3573 and a latching arm 3575 both of elastic material. The connecting arm 3573 and the latching arm 3575 are positioned on two opposite edges of the protective cover 357. The latching arm 3575 includes a hooked end formed on a free end thereof.

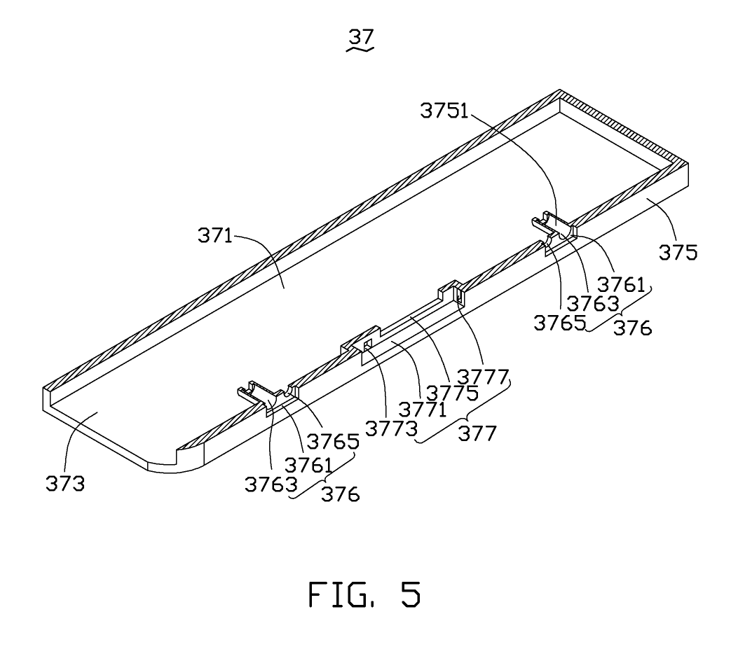

FIG. 5 shows a cross-section of casing 37 including an accommodating chamber 371 for receiving the blade 31. An end of the accommodating chamber 371 defines an opening 373. The accommodating chamber 371 includes a side portion 375 defining a first assembly portion 377 and two second assembly portions 376 symmetrical and adjacent to the first assembly portion 377.

The first assembly portion 377 includes an assembly groove 3771 defined in the side portion 375. The assembly groove 3771 defines an assembly hole 3773 and a sliding hole 3775 in a bottom thereof. A latching slot 3777 is defined in a sidewall of the assembly groove 3771.

Each of the second assembly portions 376 includes a receiving groove 3761 defined therein. A bottom of the receiving groove 3761 defines a positioning hole 3763 and a guiding hole 3765 adjacent to the positioning hole 3763. A hollow cylinder 3751 extends from a bottom of each receiving groove 3761 toward the inside, and is received in the accommodating chamber 371. The positioning hole 3763 communicates with the hollow cylinder 3751.

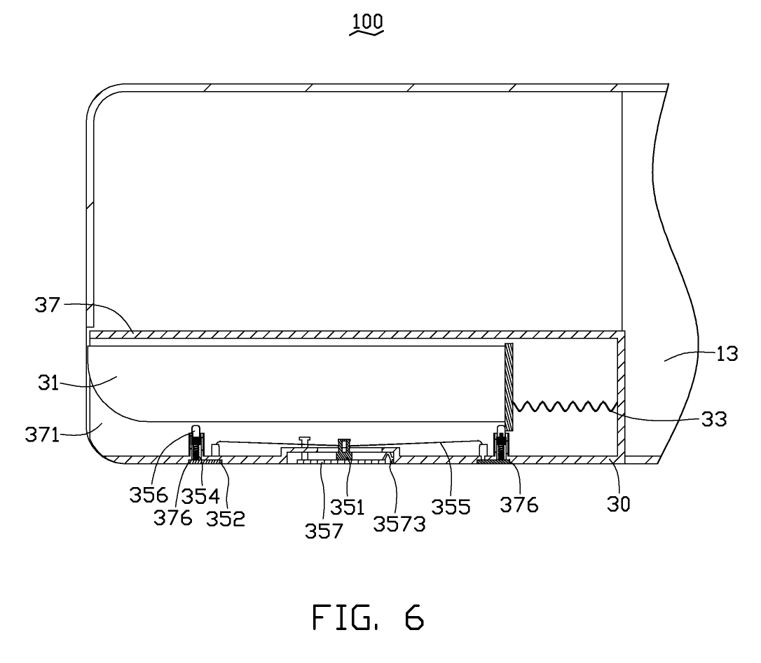

Referring to FIG. 6, during assembly, the elastic element 33 and the blade 31 are received in the accommodating chamber 371. The cable 355 runs through each guiding hole 3765, each hollow post 3523, each through hole 3525, each hollow cylinder 3751, and each spring 354. Then, the resisting elements 356 are secured on two ends of the cable 355. Each hollow post 3523 is received in the corresponding guiding hole 3765.

The spring 354 and the resisting element 356 are respectively received in each hollow cylinder 3751, and the resisting element 356 extends from the accommodating chamber 371. Each plate 3521 is received in the receiving grooves 3761. The spring 354 resist against the resisting element 356 and the plate 3521.

The sliding element 351 is slidably received in the sliding hole 3775, and is slid to the opening 373. Each resisting element 356 presses corresponding spring 354 by the cable 355, and is slid to the side portion 375. When the blade 31 is pushed into the casing 37, the sliding element 351 is released and the resisting element 356 resists the projection 315 by the spring 354. Thus, the blade 31 is received in the accommodating chamber 371.

The connecting arm 3573 runs through the assembly hole 3773. The protective cover 357 is rotated and received in the assembly groove 3771. The latching arm 3575 latches the assembly groove 3771.

The casing 37 is received in the receiving chamber 137, secured on the sheet 135, and exposed from the through slot 139. The cover 11 latches the main body 13. Thus, assembly process of the portable electronic device 100 is complete.

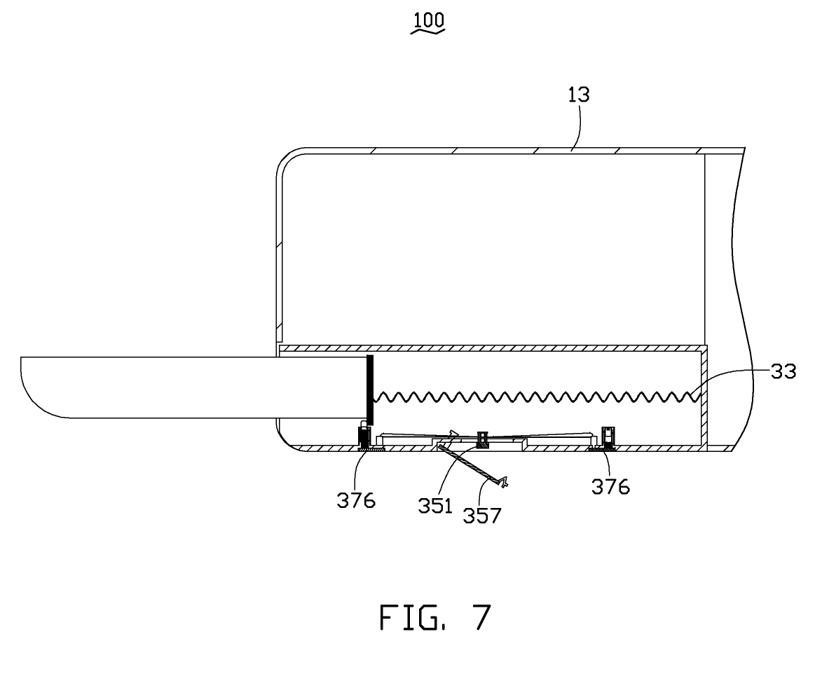

Referring to FIG. 7, during use, the protective cover 357 is rotated to expose the sliding element 351. The protective cover 357 is slid toward the opening 373. Due to the sliding element 351 is attached to the cable 355, the cable 355 can pull the resisting element 356 received in the second assembly portion 376 away from the opening 373. The resisting element 356 compresses the spring 354. When the sliding element 351 is slid by external force, the sliding element 351 drives the resisting element 356 located away from the opening 373 released from the projection 315. The blade 31 extends from the opening 373 by elastic force of the elastic element 33. The resisting element 356 located near the opening 373 resists the projection 315, thus, the blade 31 can not slide out of the casing 37. The sliding element 351 is released, the resisting element 356 located away from the opening 373 returns to an original state by an elastic force of the spring 354.

When the blade 31 is received in the casing 37, the sliding element 351 is slid away from the opening 373. The resisting element 356 located away from the opening 373 compresses the spring 354 and is slid to the side portion 375. The blade 31 is pushed into the casing 37, and the sliding element 351 is released. The resisting element 356 resists the projection 315, thus, the blade 31 is secured in the accommodating chamber 371.

It is to be understood, however, that even through numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A portable electronic device, comprising:
a main body;
a cover attached to the main body; and
a knife tool comprising:
an operating assembly;
a blade; and
an elastic element; wherein the elastic element, the operating assembly, and the blade are received in the main body;
wherein the elastic element biases the blade away from the main body towards an opening.

2. The portable electronic device as claimed in claim 1, wherein the operating assembly comprises of a sliding element, at least one locating component, and a cable; the sliding element is attached to the cable and controls the locating component with the cable.

3. The portable electronic device as claimed in claim 2, wherein the locating component includes a locating element, a spring, and a resisting element secured to the cable; the main body defines a positioning hole, and the spring and the resisting element are slidably received in the positioning hole; and the spring biases the resisting element to prevent the blade from sliding toward the opening.

4. The portable electronic device as claimed in claim 3, wherein the locating element includes a plate and a hollow post positioned on the plate; the plate defines a through hole adjacent to the hollow post; and the cable runs through the through hole and the hollow post.

5. The portable electronic device as claimed in claim 4, wherein the cable is made of metal.

6. The portable electronic device as claimed in claim 2, wherein the knife tool includes a casing received in the main body; the casing defines an accommodating chamber including a side portion; the side portion includes a first assembly portion, defining a sliding hole, and at least one second assembly portion; and the sliding element is slidably received in the sliding hole.

7. The portable electronic device as claimed in claim 6, wherein the first assembly portion comprises of an assembly groove defining an assembly hole; the locating component further comprises of a protective cover comprising a connecting arm and a latching arm; the latching arm latches to the assembly groove, and the protective cover rotates about the connecting are that is received in the assembly groove.

8. The portable electronic device as claimed in claim 7 wherein the connecting arm and a latching arm are made of elastic material.

9. The portable electronic device as claimed in claim 6, wherein the second assembly portion includes a receiving groove, a positioning hole defined in the receiving groove; the locating element includes a plate and a hollow post positioned on the plate; and the hollow post is received in the guiding hole.

10. A portable electronic device, comprising:
a main body;
a cover assembled on the main body; and
a knife tool comprising:
a casing secured in the main body;
an operating assembly;
a blade; and
an elastic element, wherein the operating assembly and the blade are received in the casing;
wherein the elastic element biases the blade away from the main body towards an opening.

11. The portable electronic device as claimed in claim 10, wherein the operating assembly comprises of a sliding element, at least one locating component, and a cable; the sliding element is attached to the cable and controls the locating component through the cable.

12. The portable electronic device as claimed in claim 11, wherein the locating component includes a locating element, a spring, and a resisting element secured to the cable; the casing defines a positioning hole, and the spring and the resisting element are slidably received in the positioning hole; and the spring biases the resisting element to prevent the blade from sliding toward the opening.

13. The portable electronic device as claimed in claim 12, wherein the locating element includes a plate and a hollow post positioned on the plate; the plate defines a through hole adjacent to the hollow post; and the cable runs through the through hole and the hollow post.

14. The portable electronic device as claimed in claim 13, wherein the cable is made of metal.

15. The portable electronic device as claimed in claim 12, wherein the casing defines an accommodating chamber including a side portion; the side portion includes a first assembly portion defining a sliding hole and at least one second assembly portion; the sliding element is slidably received in the sliding hole.

16. The portable electronic device as claimed in claim 15, wherein the first assembly portion comprises of an assembly groove defining an assembly hole; the locating component further comprises of a protective cover comprising a connecting arm and a latching arm; and the latching arm latches to the assembly groove, and the protective cover rotates about the connecting arm that is received in the assembly groove.

17. The portable electronic device as claimed in claim 15, wherein the connecting arm and a latching arm are made of elastic material.

18. The portable electronic device as claimed in claim 16, wherein the second assembly portion includes a receiving groove, and a positioning hole is defined in the receiving groove; the locating element includes plate and a hollow post positioned on the plate, and the hollow post is received in the guiding hole.
